(19) United States
(12) Patent Application Publication
(10) Pub. No.: US 2011/0039981 A1
(43) Pub. Date: Feb. 17, 2011

(54) EPOXY RESINS DERIVED FROM NON-SEED OIL BASED ALKANOLAMIDES AND A PROCESS FOR PREPARING THE SAME

(76) Inventors: Robert E. Hefner, Lake Jackson, TX (US); Jim D. Earls, Lake Jackson, TX (US)

Correspondence Address: The Dow Chemical Company, P.O. BOX 1967, 2040 Dow Center, Midland, MI, 48641, US

(21) Appl. No.: 12/989,471

(22) PCT Filed: May 18, 2009
(86) PCT No.: PCT/US09/44289

§ 371 Date: Oct. 25, 2010

(30) Foreign Application Priority Data
May 22, 2008 (US) 61055228

(51) Int. Cl. C08L 63/00; C08G 69/08

(52) U.S. Cl. 523/400; 528/310; 525/524

(57) ABSTRACT

An epoxy resin comprising at least one epoxy amide such as at least one of a glycidyl ether amide and a glycidyl ester amide derived from at least one non-seed oil based alkanolamide; and a process for preparing such epoxy resin. An epoxy resin composition can be prepared comprising the epoxy amide above and one or more epoxy resins other than the epoxy amide. A curable epoxy resin composition can also be made from the above epoxy resin composition which contains at least one curing agent and/or at least one curing catalyst.

### FIELD OF THE INVENTION

The present invention relates generally to epoxy resins. More specifically, the present invention relates to epoxy resins such as glycidyl ether amides and glycidyl ester amides derived from alkanolamides, in particular, non-seed oil based alkanolamides.

### BACKGROUND OF THE DISCLOSURE

Epoxy resins are one of the most widely used engineering resins, and are well-known for their use in composites with high strength fibers. Epoxy resins form a glassy network, exhibit excellent resistance to corrosion and solvents, good adhesion, reasonably high glass transition temperatures, and adequate electrical properties. Unfortunately, crosslinked, glassy epoxy resins with relatively high glass transition temperatures (>100° C.) are brittle. The poor impact strength of high glass transition temperature epoxy resins limits the usage of epoxies as structural materials and in composites.

Another major use for epoxy resins is in the preparation of coatings. While good adhesion, hardness and corrosion resistance can be achieved in said coatings, there is substantial room for improvement in the toughness and impact resistance, especially as glass transition temperature is increased. Furthermore, coatings prepared using aromatic epoxy resins suffer from chalking during exposure to sunlight. This severely limits the use of such coatings in outdoor applications.

Typical performance requirements of thermoset resins, including epoxy resins, include a high softening point (>200° C.), low flammability, hydrolytic resistance, chemical and solvent resistance, and dielectric which is stable with changes in temperature. Epoxy resins may provide these properties, but various epoxy systems may include the drawback of slow hardening cycles due to slow kinetics.

Other drawbacks to various epoxy systems are the use of solvents, the resulting reaction by-products, and/or insufficient UV stability. Solvents and reaction by-products may result in unwanted chemical exposure or release and bubble formation during cure. Insufficient UV stability may also limit the end uses of epoxy systems completely preventing their use in most outdoor applications.

Accordingly, there exists a need for improvements in the processing of epoxy resins, such as by lowering viscosities and eliminating the need for solvents. There also exists a need to improve the performance of epoxy resin coatings, such as improvements in UV stability and flexibility and damage tolerance. Therefore, it is desired to provide improved epoxy resins useful for coatings.

Others, prior to the present inventors, have tried to provide improved epoxy resins useful for coatings from seed oil based materials. For example, vegetable oils which have been epoxidized through the double bonds in the backbone, and used in blends with the diglycidyl ether of bisphenol A is disclosed in Frischinger, P. Muturi, S Dirlikov, Two Phase Interpenetrating Epoxy Thermosets that Contain Epoxidized Triglyceride Oils Part II, Applications, Advances in Chemistry Series (1995), 239 (Interpenetrating Polymer Networks), 539-56.

H. Bjornberg, Novel Primary Epoxides, WO 00118751, Apr. 6, 2000, discloses that products obtained by esterifying an alcohol with an alkenoic acid may be epoxidized through the terminal double bonds and used in blends with the diglycidyl ether of bisphenol A.

Poly(glycidyl ethers), NL 660241 1, Aug. 8, 1966 discloses that poly(glycidyl ethers) of castor oil are prepared by reaction of castor oil with epihalohydrin in the presence of a Lewis acid catalyst with formation of polyhalohydrin esters of castor oil after which the latter are dehydrohalogenated to form epoxy resins.

J. L. Cecil, W. J. Kurnik, D. E. Babcock, Coating Compositions Containing Glycidyl Ethers of Fatty Esters, U.S. Pat. No. 4,786,666, Nov. 22, 1988, disclose high-solids coating compositions based on bisphenol diglycidyl ethers, castor oil polyglycidyl ethers, bisphenols, fatty acids and dimmer acids.

S. F. Thames, H. Yu, R. Subraminian, Cationic Ultraviolet Curable Coatings from Castor Oil, Journal of Applied Polymer Science (2000), 77(1), 8-13, disclose coatings formulated from castor oil glycidyl ether, epoxy resin UVR 6100, and photoinitiator UVI 6990.

None of the above prior art has met the long felt need of providing an epoxy resin based on non-seed oil alkanolamides with improved performance because:

(1) The epoxy monomers cited in the prior art have higher epoxide equivalent weights due to their structure and higher oligomer content. This reduces crosslink densities and resultant thermo/mechanical properties of cured materials. (2) Most of the prior art is for epoxies with non-glycidyl ether structures due to the method of their preparation (oxidation of double bonds). Lacking the glycidyl ether structure dramatically reduces the reactivity of these epoxies with curing agents, such as diamines.

### SUMMARY OF THE INVENTION

One aspect of the present invention is directed to an epoxy resin comprising at least one epoxy amide derived from at least one non-seed oil based alkanolamides.

In one embodiment, the present invention is directed to an epoxy resin comprising at least one of a glycidyl ether amide and a glycidyl ester amide derived from at least one non-seed oil based alkanolamide.

Another aspect of the present invention is directed to a process for preparing the above epoxy resin comprising reacting together: (a) at least one non-seed oil based alkanolamide, (b) an epihalohydrin, and (c) a basic acting substance.

Still another aspect of the present invention is directed to an epoxy resin composition comprising the epoxy amide described above; and one or more epoxy resins other than the epoxy amide described above.

Yet another aspect of the present invention is directed to a curable epoxy resin composition comprising the epoxy resin composition described above; and at least one curing agent and/or at least one curing catalyst.

Other aspects and advantages will be apparent from the following description and the appended claims.

### DETAILED DESCRIPTION OF THE PREFERRED EMBODIMENTS

In one aspect, embodiments disclosed herein relate to improvements in the processing and performance of epoxy resin coatings. More specifically, embodiments disclosed herein relate to new glycidyl ethers and glycidyl esters derived from alkanolamides which are non-seed oil based. These glycidyl ethers and glycidyl esters may be used alone or in combination with other epoxy resins, and may result in improved processing, UV stability, and flexibility/damage tolerance of the resulting epoxy resins, coatings, composites, adhesives, electronics, and molded articles.

As noted above, the epoxy resins of the present invention are epoxy resins based on non-seed oil alkanolamides. For example, the epoxy resins of the present invention disclosed herein may include glycidyl ethers and glycidyl esters derived from non-seed oil based alkanolamides. The glycidyl ethers and glycidyl esters may be represented by Formula I as follows:

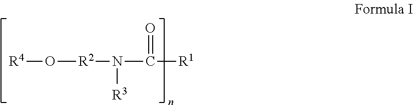

wherein R¹ is a monovalent hydrocarbyl or divalent hydrocarbylene moiety; R² is a divalent hydrocarbylene moiety; R³ is hydrogen (H) or a monovalent hydrocarbyl moiety, or a moiety represented by the following Formula II:

—R²—O—R⁴ Formula II

wherein R² is as defined above, and R⁴ is a moiety of either Formula III or Formula IV as follows:

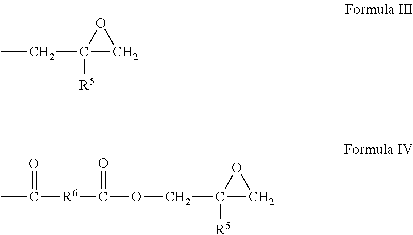

wherein R⁵ is hydrogen (H) or an aliphatic hydrocarbon group having from 1 to about 4 carbon atoms; R⁶ is a divalent hydrocarbylene moiety; and n is either 1 or 2.

By “hydrocarbylene moiety” used herein it is meant a divalent moiety selected from the group consisting of an alkyl, a cycloalkyl, a polycycloalkyl, an alkenyl, a cycloalkenyl, a polycycloalkenyl, an aromatic ring substituted alkyl, an aromatic ring substituted cycloalkyl, an aromatic ring substituted polycycloalkyl, an aromatic ring substituted alkenyl, an aromatic ring substituted cycloalkenyl, and an aromatic ring substituted polycycloalkenyl moiety.

By “hydrocarbyl moiety” used herein it is meant a monovalent moiety selected from the group consisting of an alkyl, a cycloalkyl, a polycycloalkyl, alkenyl, cycloalkenyl, polycycloalkenyl, aromatic ring substituted alkyl, aromatic ring substituted cycloalkyl, aromatic ring substituted polycycloalkyl, aromatic ring substituted alkenyl, aromatic ring substituted cycloalkenyl, aromatic ring substituted polycycloalkenyl moiety.

When R¹ is a moiety containing an aromatic ring, said aromatic ring may contain one or more substituents including a halogen atom, preferably chlorine or bromine, a nitrile group, a nitro group, an alkyl or alkoxy group containing 1 to about 6, preferably 1 to about 4, most preferably 1 to about 2 carbon atoms which may be substituted with one or more halogen atoms, preferably chlorine or bromine, or an alkenyl or alkenyloxy group containing 1 to about 6, preferably 1 to about 4, most preferably 1 to about 3 carbon atoms Likewise, R¹, R², and R³ when it is a moiety other than H, may each independently contain one or more substituents including a halogen atom, preferably chlorine or bromine, an alkoxy group, an alkenyloxy group, an ether linkage (—O—), or a thioether linkage (—S—). When R¹ or R³ is an alkyl or alkenyl moiety, is may be linear (straight chained) or branched. The terms “cycloalkyl” and “cycloalkenyl” as used herein are also intended to encompass the corresponding di and polycyclo moieties.

In some embodiments, glycidyl ethers and glycidyl esters compositions disclosed herein may additionally include one or more of the following: monoglycidyl ethers or monoglycidyl esters derived from non-seed oil based alkanolamides; oligomers of the glycidyl ethers or glycidyl esters derived from non-seed oil alkanolamides; and combinations thereof.

The glycidyl ethers and glycidyl esters described above may be used alone or in combination with other epoxy resins. The ratio of glycidyl ethers and glycidyl esters described above to other epoxy resins in a composition may range from about 1:0 to about 0.05:0.95 in some embodiments; from about 0.4:0.6 to about 0.7:0.3 in other embodiments. In other embodiments, the amount of the glycidyl ethers s and glycidyl esters described above may be in the range from about 0.05 percent to about 90 percent by weight, based on the total weight of the epoxy resin.

In general, the epoxy resins of the present invention may be prepared by a process (e.g., an epoxidation reaction process) comprising reacting together the following components: (a) a non-seed oil based alkanolamide or a mixture of non-seed oil based alkanolamides; (b) an epihalohydrin; and (c) a basic acting substance, preferably in a solid form. The process for preparing the epoxy resin of the present invention may also optionally comprise any one or more of the following components: (d) a solvent; (e) a catalyst; and/or (f) a dehydrating agent.

The epoxidation process for forming the epoxy resins of the present invention avoids any significant hydrolysis of the amide linkages that are present in the non-seed oil based alkanolamides. If hydrolysis is encountered in the operation of the process of the present invention, then optionally one or more dehydrating agents, component (f), may be employed in the process to prevent hydrolysis of amide linkages. The process of the present invention typically achieves epoxidation of at least 80% or more of theoretical while maintaining the structural integrity of the amide linkages.

In one embodiment, the process for preparing the epoxy resins of the present invention involves an initial reaction of the non-seed oil based alkanolamide with the epihalohydrin to form a halohydrin intermediate. The halohydrin intermediate is then reacted with the basic acting substance to convert the halohydrin intermediate to the epoxy resin final product (the glycidyl ether and/or glycidyl ester).

In another embodiment, an alkali metal or alkaline earth metal hydroxide may be used as a catalyst; and if such catalyst is employed in stoichiometric or greater quantities, the initial reaction of the non-seed oil based alkanolamides and the epihalohydrin produces the halohydrin intermediate in situ. The halohydrin intermediate produced in situ may then be converted to the epoxy resin final product without the addition of the basic acting substance.

By “non-seed oil” it is meant an alkanolamide that is not based on the aminolysis of a saturated and unsaturated fatty acid ester; a saturated and unsaturated fatty acid; or saturated and unsaturated fatty acid triglyceride.

The non-seed oil based alkanolamides used in the embodiments of the present invention to prepare the epoxy resins disclosed herein include, for example, any aliphatic or cycloaliphatic mono-, di- or polyhydroxy compounds containing one or more amide moieties; and mixtures thereof. Non-limiting examples of the non-seed oil based alkanolamides include N,N,N′,N′-Tetrakis (2-hydroxyethyl)cyclohexanamide; N,N,N′,N′-Tetrakis(2-hydroxyethyl) adipamide and N,N,N′,N′-Tetrakis(2-hydroxyethyl)succinamide; N,N-(2-hydroxyethyl)dodecanamide; and mixtures thereof.

Other representative examples of the non-seed oil based alkanolamides useful in the present invention include the following compounds:

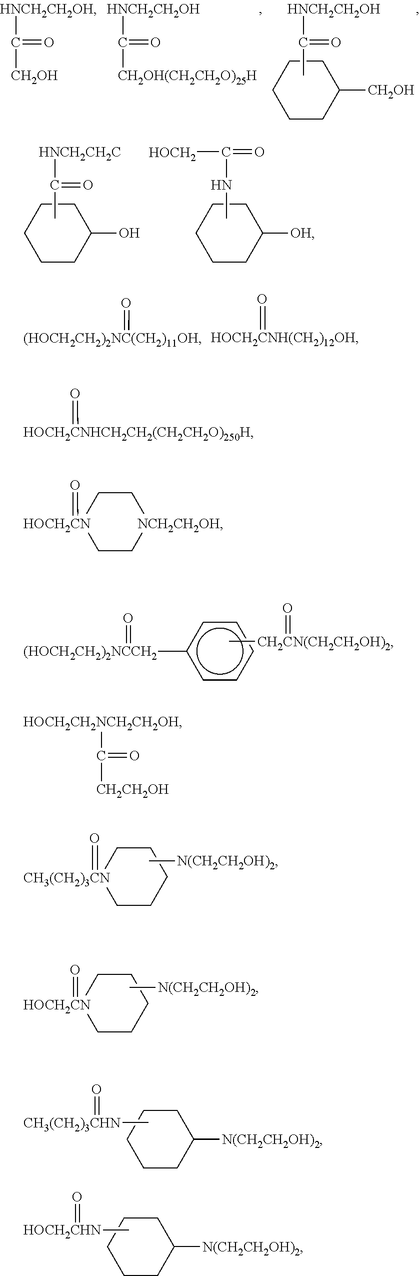

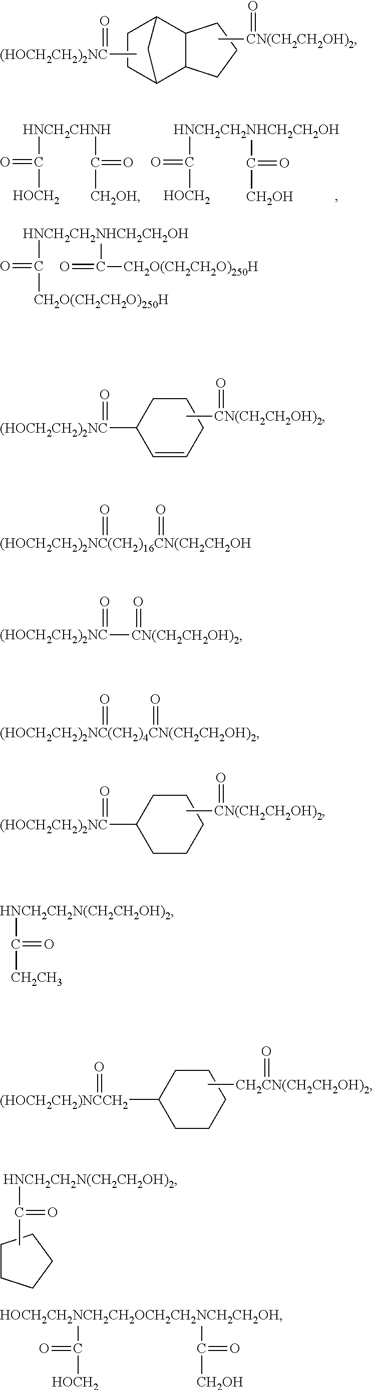

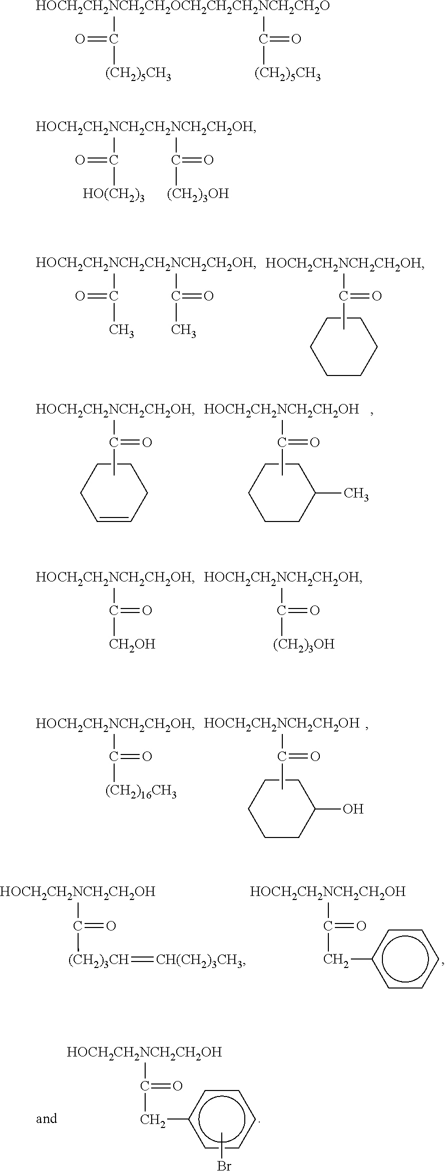

The non-seed oil based alkanolamides useful in the present invention may be purchased from commercially available products on the market. For example, commercially available non-seed oil based alkanolamides include PRIMID XL-552, a hydroxyl alkanolamide derived from adipic acid and diethanolamine, available from EMS-PRIMID.

In another embodiment, non-seed oil based alkanolamides useful in the present invention may be produced by various known methods. For example, in one method for preparing the non-seed oil based alkanolamides, functionalized non-seed oil based acid esters and diesters may be reacted, for example, by the aminolysis of a non-seed oil based carboxylic acid ester or carboxylic acid, using the method disclosed in co-pending U.S. patent application Ser. No. ______, filed of even date herein (Attorney Docket No. 65426), which is incorporated herein by reference.

As an illustration of one embodiment of aminolysis, the aminolysis method may include a reaction of non-seed oil based acid esters with amino diols and polyols, such as diethanolamine, 2-amino-2-methyl-1,3-propanediol, 2-amino-2-hydroxymethyl-1,3-propanediol, 2-(methylamino) ethanol; mixtures thereof; and the like.

In another method for preparing non-seed oil based alkanolamides, amino monols, diols, and polyols may be reacted with non-seed oil based hydroxycarboxylic acids or carboxylic acid esters. Exemplary of this method is the reaction of monoethanolamine with glycolic acid or a glycolic acid ester to give the amide diol. Also exemplary of this method is the reaction of diethanolamine with hydroxycyclohexane monocarboxylic acid ester to give the amide triol.

Similarly, diamines and polyamines many be reacted with hydroxycarboxylic acids or carboxylic acid esters to provide non-seed oil based alkanolamides. Exemplary of this method is the reaction of ethylenediamine with two equivalents of 1-hydroxydodecanoic acid or a 1-hydroxydodecanoic acid ester to give the diamide diol. Also exemplary of this method is the reaction of piperazine with two equivalents of glycolic acid or a glycolic acid ester to give the diamide diol.

Likewise, non-seed oil based alkanolamides may be prepared through condensation reaction of dicarboxylic acids or acid esters with amino monols, diols, or polyols. Exemplary of this method is the reaction of diethanolamine with adipic acid or an adipic acid ester to give the diamide tetrol. Also exemplary of this method is the reaction of monoethanolamine with cyclohexanedicarboxylic acid or cyclohexanedicarboxylic acid ester to give the diamide diol.

Examples of epihalohydrin used to prepare the epoxy resins of the present invention disclosed herein include, for example, epichlorohydrin, epibromohydrin, epiiodohydrin, methylepichlorohydrin, methylepibromohydrin, methylepiiodohydrin, and any combination thereof. Epichlorohydrin is the preferred epihalohydrin used in embodiments disclosed herein.

The ratio of the epihalohydrin to the non-seed oil based alkanolamide is generally from about 1:1 to about 25:1, preferably from about 1.8:1 to about 10:1, and more preferably from about 2:1 to about 5:1 equivalents of epihalohydrin per primary hydroxyl group in the non-seed oil based alkanolamide.

The term “primary hydroxyl group” used herein refers to the primary hydroxyl group or primary hydroxyl groups derived from the non-seed oil based alkanolamides. The primary hydroxyl group differs from a secondary hydroxyl group such as those formed during the process of the formation of the halohydrin intermediate.

A basic acting substance may be used in the present invention to react with the aforementioned halohydrin intermediate to form the final epoxy resin product of the present invention disclosed herein. Examples of the suitable basic acting substance used in the present invention include alkali metal hydroxides, alkaline earth metal hydroxides, carbonates, bicarbonates; any mixture thereof; and the like.

More specific examples of the basic acting substance useful in the present invention include sodium hydroxide, potassium hydroxide, lithium hydroxide, calcium hydroxide, barium hydroxide, magnesium hydroxide, manganese hydroxide, sodium carbonate, potassium carbonate, lithium carbonate, calcium carbonate, barium carbonate, magnesium carbonate, manganese carbonate, sodium bicarbonate, potassium bicarbonate, magnesium bicarbonate, lithium bicarbonate, calcium bicarbonate, barium bicarbonate, manganese bicarbonate; any combination thereof; and the like. Sodium hydroxide and/or potassium hydroxide are the preferred basic acting substance useful in the present invention.

The process of the present invention disclosed herein may be conducted in the absence of solvent or in the presence of a solvent. If the solvent is absent in the process, the epihalohydrin may function both as a solvent and as a reactant in such process. If the solvent is present in the process, the solvent used should be inert to the process of preparing the epoxy resins disclosed herein, including inert to the reactants, the catalysts, any intermediate products formed during the process, and the final products.

Examples of solvents which may be used in the present invention include aliphatic and aromatic hydrocarbons, halogenated aliphatic hydrocarbons, aliphatic ethers, aliphatic nitriles, cyclic ethers, ketones, amides, sulfoxides; any combination thereof; or the like. Other solvents used in the present invention may include, for example, pentane, hexane, octane, toluene, xylene, methylethylketone, methylisobutylketone, N,N-dimethylformamide, dimethylsulfoxide, diethyl ether, tetrahydrofuran, 1,4-dioxane, dichloromethane, chloroform, ethylene dichloride, methyl chloroform, ethylene glycol dimethyl ether, N,N-dimethylacetamide, acetonitrile; any combination thereof; or the like.

If a solvent is used in the process of the present invention, a minimum amount of solvent needed to achieve the desired result is preferred. In general, the solvent may be present in the process from about 250 percent to about 1 percent by weight, preferably, from about 50 percent to about 1 percent by weight, and more preferably, from about 20 percent to about 5 percent by weight based on the total weight of the non-seed oil based alkanolamides. The solvent may be removed at the completion of the reaction of forming the epoxy resins described herein using conventional methods, such as vacuum distillation.

A catalyst may also, optionally, be used in the present invention to prepare the epoxy resins described herein. Examples of the catalyst useful in the present invention include quaternary ammonium or phosphonium halides. More specific examples of the catalyst useful in the present invention include benzyltrimethylammonium chloride, benzyltrimethylammonium bromide, tetrabutylammonium chloride, tetrabutylammonium bromide, tetraoctylammonium chloride, tetraoctylammonium bromide, tetrabutylammonium bromide, tetramethylammonium chloride, tetramethylammonium bromide, tetrabutylphosphonium chloride, tetrabutylphosphonium bromide, tetrabutylphosphonium iodide, ethyltriphenylphosphonium chloride, ethyltriphenylphosphonium bromide, ethyltriphenylphosphonium iodide; any combination thereof; or the like.

While the amount of catalyst may vary due to factors such as reaction time and reaction temperature, the lowest amount of catalyst required to produce the desired effect is preferred. In general, the catalyst may be used in an amount of from about 0.01 percent to about 3 percent by weight, preferably, from about 0.05 percent to about 2.5 percent by weight, and more preferably, from about 0.1 percent to about 1 percent by weight based on the total weight of the non-seed oil based alkanolamides.

In preparing the epoxy resins of the present invention, other components may be present or purposely added in minor amounts to the non-seed oil based alkanolamides. Examples of minor components which may be purposely added to the non-seed oil based alkanolamides include aliphatic diols, aliphatic polyols, and cycloaliphatic diols, other than the non-seed oil based alkanolamides.

More specific examples of the minor components include ethylene glycol, diethylene glycol, poly(ethylene glycol)s, trimethylolpropanes, cyclohexane diols, norbornane dimethanols, and dicyclopentadiene dimethanols; any combination thereof; or the like. The diols or polyols may be epoxidized simultaneously during the epoxidation of the non-seed oil based alkanolamides. The resultant epoxy resin comprises a mixture of the epoxy resin produced from the non-seed oil based alkanolamides and the epoxy resin produced from the respective aliphatic diols, aliphatic polyol, or cycloaliphatic diol, other than the non-seed oil based alkanolamides. In this manner, a specific mixture of epoxy resins may be obtained without mixing of epoxy resins from separate sources. This may be done to obtain specific properties, such as, for example, a reduction in viscosity relative to the viscosity of the epoxy resin of the non-seed oil based alkanolamides without the minor components.

The amounts and types of the minor components may vary depending on the specific chemistry of the components and the process used to prepare the non-seed oil based alkanolamides. In general, the non-seed oil based alkanolamides may comprise less than about 25 percent, preferably from about 0.001 percent to about 10 percent, and more preferably from about 0.001 percent to about 1 percent minor components based on the total weight of the non-seed oil based alkanolamides.

The process for preparing the epoxy resins of the present invention may be carried out under various conditions. For example, the temperature for the process for preparing the epoxy resins described herein is generally from about 20° C. to about 120° C., preferably from about 30° C. to about 85° C., and more preferably from about 40° C. to about 75° C.

The pressure for the process for preparing the epoxy resins described herein is generally from about 30 mm Hg to about 100 psia, preferably from about 30 mm Hg to about 50 psia, and more preferably from about 60 mm Hg to about atmospheric pressure (e.g., about 760 mm Hg).

The time for completion of the process for preparing the epoxy resins described herein is generally from about 1 hour to about 120 hours, more preferably from about 3 hours to about 72 hours, and most preferably from about 4 hours to about 48 hours.

Various analytical methods (e.g., gas chromatography (GC), high performance liquid chromatography (HPLC), and gel permeation chromatographic (GPC)) may be used to determine the completion of the process for preparing the epoxy resins described herein. The exact analytical method selected depends on the structure of the reactants and the epoxy resin products. For example, HPLC may be employed to monitor the reaction of the non-seed oil based alkanolamides concurrently with the formation of intermediate products and final products (e.g., the diglycidyl ethers s and diglycidyl esters derived from the non-seed oil based alkanolamides, the mono and diglycidyl ethers of non-seed oil based alkanolamides, and any oligomer thereof). GPC analysis may also be employed to analyze the oligomers which are not volatile and are generally not detected by analytical methods such as gas chromatography.

Other analytical methods, such as infrared spectrophotometric (IR) analysis and nuclear magnetic resonance (NMR) spectroscopy, are beneficially used to analyze the epoxy resin of the non-seed oil based alkanolamide. For example, IR analysis can be performed to readily verify retention of the amide structure in the epoxy resin product.

In addition, using analytical methods to monitor the epoxidation process, the epoxy resins described herein with various components may be obtained. For example, a shorter reaction time and/or a lower reaction temperature generally leads to the formation of epoxy resins comprising a greater amount of the monoglycidyl ethers of non-seed oil based alkanolamides accompanied by a lesser amount of the oligomers of such epoxy resins. Conversely, a longer reaction time and/or a higher reaction temperature generally leads to the formation of epoxy resins comprising a lesser amount of the monoglycidyl ethers of non-seed oil based alkanolamides accompanied by a greater amount of the oligomers of such epoxy resins. Accordingly, the combination of reaction time and reaction temperature may be adjusted to provide the desired epoxy resins.

According to various embodiments, the epoxy resins of the present invention described herein may be prepared by various epoxidation processes including for example (1) a slurry epoxidation process, (2) an anhydrous epoxidation process, or (3) a combination of a Lewis acid catalyzed coupling reaction and a slurry epoxidation reaction process.

### Slurry Epoxidation Process

The slurry epoxidation process useful in the present invention comprises reacting together the following components: (a) a non-seed oil based alkanolamide such as any of the aforementioned non-seed oil based alkanolamides, (b) an epihalohydrin such as any of the aforementioned epihalohydrins, and (c) a basic acting substance in a solid form or in an aqueous solution such as any of the aforementioned basic acting substances.

The slurry epoxidation process may optionally comprise any one or more of the following components: (d) a solvent or a mixture of solvents other than water, (e) a catalyst, and/or (f) a dehydrating agent. If hydrolysis is encountered in the operation of the slurry epoxidation process of the present invention, then one or more dehydrating agents (f) may be employed in the process to prevent hydrolysis of amide linkages.

In the slurry epoxidation process, when the basic acting substance is in a solid form, it is usually in the form of a pellet, a bead, or a powder. Various particle sizes or particle size distributions of the basic acting substance may be used. For example, the basic acting substance, such as solid sodium hydroxide, having a particle size distribution of from about −40 to about +60 mesh, or from about −60 to about +80 mesh may be used. In another embodiment, the particle size distribution used may be about −80 mesh.

In the slurry epoxidation process, when the basic acting substance is obtained as an aqueous solution, the aqueous solution is first added to the solvent or a mixture of solvents other than water to form a solvent-water azeotrope or a co-distillable mixture with the solvent or the mixture of solvents and water. The water in this aqueous solution of the basic acting substance can be removed via an azeotropic distillation of the solvent-water azeotrope or co-distillation of water with the solvent or a mixture of solvents. This distillation is usually done under vacuum. The distillation may be performed continuously until the desired basic acting substance is produced either as a neat solid (dry) or as a solvent slurry (with residual non-aqueous solvent). If residual solvent is left behind to form a solvent slurry of the basic acting substance, the solvent used should be inert to the slurry epoxidation reaction including the reactants, any intermediate products, and the final products. Examples of such solvents include toluene and xylene.

The term “azeotrope” refers herein to a mixture of liquids (e.g., mixture of solvent and water in the slurry epoxidation process) that has a constant boiling point because the vapor form of the mixture has the same composition as the liquid form of the mixture. The components of the mixture usually cannot be separated by simple distillation.

The term “codistillate” refers herein to a mixture of liquids wherein water codistills with solvent. It is also possible to simply flash distill water from the aqueous solution of the basic acting substance to leave the dry basic acting substance behind as a solid.

Azeotropic distillation is a process for separating, by distillation, a product which is not easily separable otherwise. The essential characteristic of the process is an introduction of another component which forms an azeotropic mixture with an initial component in the product and the initial component is then distilled off leaving to obtain a pure product.

A dehydrating agent may also be used in the slurry epoxidation process to moderate or accelerate the slurry epoxidation reaction. The dehydrating agent may be added before, after or concurrent with the basic acting substance. The addition and use of said dehydrating agent is crucial with certain alkanolamide reactants to prevent hydrolysis of amide linkages.

Examples of the dehydrating agent include alkali metal sulfates, alkaline earth metal sulfates, molecular sieves; any combination thereof; or the like. More specific examples of the dehydrating agent include sodium sulfate, potassium sulfate, lithium sulfate, calcium sulfate, barium sulfate, magnesium sulfate, manganese sulfate, molecular sieves; any combination thereof; or the like.

In one embodiment of the slurry epoxidation process, the process involves adding the non-seed oil based alkanolamide to a stirred slurry of sodium hydroxide in epichlorohydrin. The sodium hydroxide may be in the form of a solid such as pellets, beads or powder or a mixture thereof. The solid sodium hydroxide may also be essentially anhydrous to slightly damp. The term “essentially anhydrous” or “slightly damp” as used herein means that the solid sodium hydroxide comprises less than about 5 percent by weight of water based on the total weight of the solid sodium hydroxide.

In general, the solid sodium hydroxide comprises less than about 5 percent, preferably less than about 4 percent, and more preferably less than about 2.5 percent by weight of water based on the total weight of the solid sodium hydroxide.

In another embodiment of the slurry epoxidation process, the process involves adding the non-seed oil based alkanolamide to a stirred slurry of sodium hydroxide and anhydrous sodium sulfate, in epichlorohydrin. The basic acting substance, i.e. the sodium hydroxide and sodium sulfate, may be in the form of a solid such as pellets, beads, powder, or granular. The solid sodium hydroxide may also be essentially anhydrous or to slightly damp, comprising less than about 5 percent by weight of water based on the total weight of the solid sodium hydroxide. The anhydrous sodium sulfate is preferred to be in the granular form.

According to the present disclosure, it is desired to produce the epoxy resin comprising the highest possible amount of the diglycidyl ethers and diglycidyl esters of the non-seed oil based alkanolamides concurrent with retention of the amide structure in said epoxy resin. However, it has been discovered that, during the slurry epoxidation process, as the reaction reaches about 95 weight percent or higher conversion of the non-seed oil based alkanolamides to the epoxy resin product, the viscosity of the reaction slurry increases, which causes significant reduction in mixing and effective heat transfer from the reaction slurry. The increased viscosity makes it difficult to continue the reaction. Furthermore, under these conditions, a substantial amount of monoglycidyl ethers of non-seed oil based alkanolamides may still be present. In order to reduce viscosity, concomitantly restore heat transfer, and thus continue the reaction, a further addition (also referred as “back-addition”) of epichlorohydrin may be needed. Preferably, the epichlorohydrin may be back-added in an additional amount of from about 0.25 to about 1 equivalent of epichlorohydrin per primary hydroxyl originally present in the non-seed oil based alkanolamides.

In the slurry epoxidation process, it is within the scope of the embodiments of the present invention disclosed herein to add a greater amount of epichlorohydrin at the inception of the reaction for eventual viscosity control. Generally an additional amount of from about 0.50 to about 2 equivalents of epichlorohydrin per primary hydroxyl originally present in the non-seed oil based alkanolamides may be added at the inception of the reaction. However, it has been discovered that during the slurry epoxidation process, increasing epichlorohydrin stoichiometry above about 2 to about 3 equivalents of epichlorohydrin per primary hydroxyl in the mixture at the inception of the reaction may lead to additional formation of unwanted side-products. The formation of these unwanted side-products may consume valuable epihalohydrin as well as the basic acting substance, such as sodium hydroxide. The side-products, if formed, may be removed by vacuum distillation.

The epoxy resins of the present invention may also be prepared by an anhydrous epoxidation process. The anhydrous epoxidation process comprises reacting together the following components: (a) a non-seed oil based alkanolamide such as any of the aforementioned non-seed oil based alkanolamides, (b) an epihalohydrin such as any of the aforementioned epihalohydrins, and (c) a basic acting substance in an aqueous solution such as any of the aforementioned basic acting substances. The anhydrous epoxidation process may optionally comprise any one or more of the following components: (d) a solvent, and/or (e) a catalyst.

In the anhydrous epoxidation process, a basic acting substance in an aqueous solution may be used. The water in the aqueous solution of the basic acting substance and the epihalohydrin (e.g., epichlorohydrin) form a binary epihalohydrin-water azeotrope or a ternary epihalohydrin-water-solvent azeotrope. The water may be removed via an azeotropic distillation or co-distillation of the epichlorohydrin-water azeotrope or the epihalohydrin-water-solvent azeotrope. The distillation may be performed under vacuum.

Details concerning the process of the removal of water during epoxidation via azeotropic distillation or co-distillation are given in U.S. Pat. No. 4,499,255, which is incorporated herein by reference.

In one embodiment of the anhydrous epoxidation process, the anhydrous epoxidation process involves controlled addition of the sodium hydroxide in an aqueous solution to a stirred mixture of the non-seed oil based alkanolamides and epichlorohydrin with continuous vacuum distillation of an epichlorohydrin-water azeotrope, removal of the water fraction from the distilled azeotrope, and recycle of the recovered epichlorohydrin back into the reaction. An aqueous solution comprising about 50 percent by weight of sodium hydroxide is particularly preferred. More dilute aqueous sodium hydroxide, while operable, is less preferred due to the additional time and energy expended to remove the additional water. A catalyst may also be added to the stirred mixture. A quaternary ammonium halide catalyst is particularly preferred.

If hydrolysis of amide linkages is encountered in the operation of the anhydrous epoxidation process, then one of the other epoxidation processes of the present invention is employed to prevent hydrolysis of said amide linkages.

### Lewis Acid Catalyzed Coupling/Slurry Epoxidation Process

The epoxy resins of the present invention may also be prepared by a Lewis acid catalyzed coupling reaction and slurry epoxidation reaction process (herein the “Lewis acid coupling/epoxidation process”). Generally, the Lewis acid coupling/epoxidation process comprises a catalyzed coupling reaction step followed by a slurry epoxidation step. Accordingly, the Lewis acid coupling/epoxidation process comprises first reacting, in a coupling reaction step, (a) a non-seed oil based alkanolamide such as any of those described above, with (b) an epihalohydrin, such as any of those described above, in the presence of (c) a Lewis acid catalyst such as any of the catalysts described above. The coupling reaction step produces an intermediate product comprising a halohydrin. The intermediate product is then reacted in a dehydrohalogenation reaction step, for example using an epoxidation process such as the slurry epoxidation process described above, with (d) a basic acting substance in a solid form. The Lewis acid coupling/epoxidation process may also optionally comprise any one or more of the following components: (e) a solvent, (f) a catalyst other than the Lewis acid catalyst, and/or (g) a dehydrating agent.

Examples of the Lewis acid used in the Lewis acid catalyzed coupling reaction step of the Lewis acid catalyzed coupling/slurry epoxidation process include boron trifluoride or a boron trifluoride complex, such as boron trifluoride etherate; tin (IV) chloride; aluminum chloride; ferric chloride; zinc chloride; silicon tetrachloride; titanium tetrachloride; antimony trichloride; any mixtures thereof; or the like.

The amount of the Lewis acid used may range from about 0.00015 to about 0.015, preferably from about 0.00075 to about 0.0075, and more preferably from about 0.0009 to about 0.005 moles per mole of the non-seed oil based alkanolamide. The amount of the Lewis acid may also depend on particular reaction variables such as reaction time and reaction temperature.

In one embodiment of the Lewis acid catalyzed coupling reaction step of the Lewis acid coupling/epoxidation process, the coupling reaction involves adding the epichlorohydrin to a stirred mixture or solution of the non-seed oil based alkanolamide and the Lewis acid catalyst to produce an intermediate product comprising chlorohydrin. Tin (IV) tetrachloride is particularly preferred as the Lewis acid catalyst. Once the reaction is complete, the intermediate product is then reacted in the slurry epoxidation process in a dehydrohalogenation reaction with sodium hydroxide as a solid.

In another embodiment, the resultant intermediate product obtained from the Lewis acid coupling reaction step is subsequently reacted using the slurry epoxidation process, in a dehydrohalogenation reaction step, with sodium hydroxide and anhydrous sodium sulfate as solids.

A catalyst other than the Lewis acid catalysts may also be used to prepare the epoxy resins. If used, the non-Lewis acid catalyst may be added at any time during the slurry epoxidation or anhydrous epoxidation processes, but is added only to the dehydrohalogenation reaction step (slurry epoxidation process) of the Lewis acid coupling/epoxidation process.

In a manner similar to the Lewis acid catalyzed coupling reaction step as described above, an alkali metal hydride may also be added to react with the non-seed oil based alkanolamides followed by the reaction of the resultant alkoxide with the epihalohydrin. Examples of the alkali metal hydride which may be used include sodium hydride, potassium hydride, and any mixture thereof or the like, with sodium hydride being the preferred alkali metal hydride. The intermediate product is then reacted in a dehydrohalogenation reaction step using the slurry epoxidation process with (d) a basic acting substance in a solid form. The process that employs the alkali metal hydride may also optionally comprise any one or more of the following components: (e) a solvent, (f) a catalyst other than the Lewis acid catalyst, and/or (g) a dehydrating agent.

The slurry epoxidation or anhydrous epoxidation processes may also be conducted in the absence of a solvent, with epichlorohydrin being used in an amount to function as both solvent and reactant. For example, the slurry epoxidation process may be conducted by reacting the non-seed oil based alkanolamides with the epihalohydrin in a ratio of from about 2 to about 3 equivalents of epihalohydrin per primary hydroxyl in the mixture. This slurry epoxidation process provides an easily mixed reaction slurry because the initial viscosity of the reaction slurry is low and the heat generated from the epoxidation process, including the heat from the reaction and heat from the stirring of the reaction mixture, can be easily transferred out of the reactor.

The process of the present invention disclosed herein may also include a recovery and purification process. The recovery and purification can be performed using methods such as gravity filtration, vacuum filtration, vacuum distillation including rotary evaporation and fractional vacuum distillation, centrifugation, water washing or extraction, solvent extraction, decantation, column chromatography, falling film distillation, wiped film distillation, electrostatic coalescence, and other known recovery and purification processing methods and the like. Falling film or wiped film distillation is a preferred method for the recovery and purification process of high purity (e.g., greater than about 99%) epoxy resin of the present invention that is substantially free of oligomer. The term “free of oligomer” or “substantially free of oligomer” used herein means that the oligomer is present at less than about 2 percent, preferably less than about 1 percent, and more preferably zero percent by weight based on the total weight of the epoxy resin final product.

The recovery and purification process comprises removing and recovering components with lower boiling points, including those components with boiling points below that of the epoxy resin of the non-seed oil based alkanolamide. Examples of these components include unreacted epihalohydrin and co-produced glycidyl ether (e.g., 2-epoxypropyl ether) side-products. The recovered epihalohydrin may be recycled (e.g., re-used as a reactant) and the diglycidyl ether side-product may be used for other purposes, such as a reactive intermediate product.

According to a preferred embodiment of the present invention, the components including those with boiling points below the epoxy resin of the non-seed oil based alkanolamides are removed via the vacuum distillation (rotary evaporation) until the total amounts of the components with boiling points below the epoxy resin of the non-seed oil based alkanolamide is less than about 0.5 percent by weight based on the total weight of the epoxy resin final product. If present, some of or all of the monoglycidyl ethers of the non-seed oil based alkanolamides may also be removed via vacuum distillation.

When none or a controlled amount of the monoglycidyl ethers of the non-seed oil based alkanolamides are removed via vacuum distillation, the process produces an epoxy resin final product comprising the di- and/or polyglycidyl ethers and esters of non-seed oil based alkanolamides, the monoglycidyl ethers and esters of non-seed oil based alkanolamides, and oligomers thereof.

When all of the monoglycidyl ethers of the non-seed oil based alkanolamides are removed via the vacuum distillation, the process produces an epoxy resin final product comprising the di- and/or polyglycidyl ethers of non-seed oil based alkanolamides and oligomers thereof. Alternately, the reaction may directly provide an epoxy resin product comprising di- and/or polyglycidyl ethers of non-seed oil based alkanolamides and oligomers thereof essentially free of any monoglycidyl ether.

In one embodiment, during the recovery and purification process, the epoxy resin produced from the slurry epoxidation reaction may be centrifuged and/or filtered to remove solid salts (e.g., unreacted sodium hydroxide and sodium chloride if epichlorohydrin is used). Components in the epoxy resin including those with boiling points below the non-seed oil based alkanolamides, and, optionally, any unreacted non-seed oil based alkanolamides are removed via vacuum distillation (rotary evaporation) to provide the epoxy resin final product of the present invention. This recovery and purification process is essentially a non-aqueous process, which has an advantage over other recovery and purification process using an aqueous solution because the recovery of waste salts as an easily disposed solid rather than the more difficult handle and dispose waste aqueous liquid generated by processes using water.

In another embodiment, the epoxy resin solution obtained after centrifuging and/or filtration of the product from the slurry epoxidation my be washed with one or more washes of water or other aqueous solutions such as, for example, sodium hydrogen carbonate or sodium dihydrogen phosphate. This again allows for recovery of the bulk of the waste salts as an easily disposed solid concurrent with removal of traces of salts or other water soluble contaminants through the wash or washes that may be deleterious to the stability of the epoxy resin product or may. Likewise, washing can beneficially lower ionic chloride levels that may be present in the epoxy resin product.

Certain of the epoxy resins disclosed herein may be non-crystallizing at room temperature (e.g., 25° C.) and may have the ability to accept high solid contents due to their low viscosity. Additionally, the epoxy resins produced by the slurry epoxidation process or the anhydrous epoxidation process typically possess low chloride (including ionic, hydrolyzable and total chloride) contents. Such epoxy resins, having a low chloride content, have advantages, which may include the following: (a) improved reactivity of the epoxy resins when cured with conventional epoxy resin curing agents, (b) increased di or polyglycidyl ether content, (c) reduced potential corrosivity of the epoxy resins, and (d) improved electrical properties of the epoxy resins. The epoxy resins produced by the Lewis acid coupling/epoxidation process may be higher in total chloride content (e.g., chloromethyl groups bound into the epoxy resin structure) compared to the slurry epoxidation process and the anhydrous epoxidation process; however, the Lewis acid catalyzed coupling reaction step has the advantage of being a relatively simple process.

According to one embodiment of the present invention, a curable epoxy resin composition may be prepared comprising (A) an epoxy resin of a non-seed oil based alkanolamide such as any of the aforementioned epoxy resins based on non-seed oil based alkanolamide described above, and (B) at least one curing agent and/or at least one curing catalyst therefore. In another embodiment of the present invention, the curable epoxy resin composition may optionally include one or more additional epoxy resin compounds (C) in addition to, but different than, the epoxy resin of the seed oil based alkanolamide (A).

The term “curable” (also referred to as “thermosettable”) means that the composition is capable of being subjected to conditions which will render the composition to a cured or thermoset state or condition.

The term “cured” or “thermoset” is defined by L. R. Whittington in Whittington's Dictionary of Plastics (1968) on page 239 as follows: “Resin or plastics compounds which in their final state as finished articles are substantially infusible and insoluble. Thermosetting resins are often liquid at some stage in their manufacture or processing, which are cured by heat, catalysis, or some other chemical means. After being fully cured, thermosets cannot be resoftened by heat. Some plastics which are normally thermoplastic can be made thermosetting by means of crosslinking with other materials.”

Component (A), the epoxy resin of a non-seed oil based alkanolamide, useful in the curable epoxy resin composition above may be any of the aforementioned epoxy resins based on non-seed oil based alkanolamides described above.

Component (B), the curing agent and/or catalyst useful for curing the curable epoxy resin composition comprising the epoxy resin of the non-seed oil based alkanolamide (A) alone, or a blend or mixture of the epoxy resin of the non-seed oil based alkanolamide (A) and the epoxy resin compound (C); may be any curing agents and/or catalysts known for curing epoxy resin.

Examples of the curing agent include aliphatic, cycloaliphatic, polycycloaliphatic or aromatic primary monoamines; aliphatic, cycloaliphatic, polycycloaliphatic or aromatic primary and secondary polyamines; carboxylic acids and anhydrides thereof; aromatic hydroxyl containing compounds; imidazoles; guanidines; urea-aldehyde resins; melamine-aldehyde resins; alkoxylated urea-aldehyde resins; alkoxylated melamine-aldehyde resins; amidoamines; epoxy resin adducts; and any combinations thereof.

Particularly suitable curing agents include, for example, methylenedianiline; isophorone diamine; 4,4′-diaminostilbene; 4,4′-diamino-α-methylstilbene; 4,4′-diaminobenzanilide; dicyandiamide; ethylenediamine; diethylenetriamine; triethylenetetramine; tetraethylenepentamine; urea-formaldehyde resins; melamine-formaldehyde resins; methylolated urea-formaldehyde resins; methylolated melamine-formaldehyde resins; phenol-formaldehyde novolac resins, cresol-formaldehyde novolac resins, sulfanilamide, diaminodiphenylsulfone, diethyltoluenediamine; t-butyltoluenediamine;

bis-4-aminocyclohexylamine; isophoronediamine; diaminocyclohexane; hexamethylenediamine; piperazine; aminoethylpiperazine; 2,5-dimethyl-2,5-hexanediamine; 1,12-dodecanediamine; tris-3-aminopropylamine; and any combinations thereof.

Examples of suitable curing catalysts include boron trifluoride, boron trifluoride etherate, aluminum chloride, ferric chloride, zinc chloride, silicon tetrachloride, stannic chloride, titanium tetrachloride, antimony trichloride, boron trifluoride monoethanolamine complex, boron trifluoride triethanolamine complex, boron trifluoride piperidine complex, pyridine-borane complex, diethanolamine borate, zinc fluoroborate, metallic acylates such as stannous octoate or zinc octoate, and any mixtures thereof.

The curing agent may be employed in an amount which will effectively cure the curable epoxy resin composition, however, the amount of the curing agent will also depend upon the particular components present in the curable epoxy resin composition, e.g., the epoxy resin reactive diluent, the epoxy resin, the type of curing agent and/or catalyst employed.

Generally, a suitable amount of curing agent may range from about 0.80:1 to about 1.50:1, and preferably from about 0.95:1 to about 1.05:1 equivalents of reactive hydrogen atom in the curing agent per equivalent of epoxide group in the epoxy resin. The reactive hydrogen atom is the hydrogen atom which is reactive with an epoxide group in the epoxy resin.

Similarly, the curing catalyst is also employed in an amount which will effectively cure the curable epoxy resin composition; however, the amount of the curing catalyst will also depend upon particular components present in the curable epoxy resin composition, e.g., the epoxy resin of the non-seed oil based alkanolamide (A) and the type of curing agent and/or catalyst employed.

Generally, a suitable amount of the curing catalyst from about 0.0001 to about 2 percent, and preferably from about 0.01 to about 0.5 percent by weight based on the total weight of the curable epoxy resin composition may be employed.

One or more of the curing catalysts may be employed in the process of curing of the curable epoxy resin composition in order to accelerate or otherwise modify the curing process.

Component (A), the epoxy resin of the non-seed oil based alkanolamide of the present invention, useful in the curable epoxy resin composition above may be used alone or may be combined with one or more different epoxy resins, Component (C), to form a mixture or blend of epoxy resins. Accordingly, the present invention also comprises a curable epoxy resin blend composition comprising the epoxy resin of the non-seed oil based alkanolamide; the epoxy resin (A) of the present invention, such as the glycidyl ether amides and glycidyl ester amides described above; the epoxy resin compound (C); and at least one curing agent and/or at least one curing catalyst (B) therefore. In a blend of epoxy resins, the weight ratio of glycidyl ethers and glycidyl esters described above to other epoxy resins (C) in a composition may range from about 1:0 to about 0.05:0.95, and preferably from about 0.4:0.6 to about 0.7:0.3.

The epoxy resins which may be used as the epoxy resin compound (C) may be any epoxide-containing compound which has an average of more than one epoxide group per molecule. The epoxide group can be attached to any oxygen, sulfur or nitrogen atom or the single bonded oxygen atom attached to the carbon atom on a

—CO—O— group. The oxygen, sulfur, nitrogen atom, or the carbon atom of the —CO—O— group may be attached to an aliphatic, cycloaliphatic, polycycloaliphatic or aromatic hydrocarbon group. The aliphatic, cycloaliphatic, polycycloaliphatic or aromatic hydrocarbon group can be substituted with any inert substituents including, but not limited to, halogen atoms, preferably fluorine, bromine or chlorine; nitro groups; or the groups can be attached to the terminal carbon atoms of a compound containing an average of more than one —(O—CHR^{a}—CHR^{a})ₜ— group, wherein each R^{a} is independently a hydrogen atom or an alkyl or haloalkyl group containing from one to two carbon atoms, with the proviso that only one R^{a} group can be a haloalkyl group, and t has a value from one to about 100, preferably from one to about 20, and more preferably from one to about 10, most preferably from one to about 5.

More specific examples of the epoxy resin suitable for the epoxy resin compound (C) include diglycidyl ethers of 1,2-dihydroxybenzene (catechol); 1,3-dihydroxybenzene (resorcinol), 1,4-dihydroxybenzene (hydroquinone), 4,4′-isopropylidenediphenol (bisphenol A), hydrogenated bisphenol A, 4,4′-dihydroxydiphenylmethane, 3,3′,5,5′-tetrabromobisphenol A, 4,4′-thiodiphenol; 4,4′-sulfonyldiphenol; 2,2′-sulfonyldiphenol; 4,4′-dihydroxydiphenyl oxide; 4,4′-dihydroxybenzophenone; 1,1′-bis(4-hydroxyphenyl)-1-phenylethane; 3,3′-5,5′-tetrachlorobisphenol A; 3,3′-dimethoxybisphenol A; 4,4′-dihydroxybiphenyl; 4,4′-dihydroxy-α-methylstilbene; 4,4′-dihydroxybenzanilide; 4,4′-dihydroxystilbene; 4,4′-dihydroxy-α-cyanostilbene; N,N′-bis(4-hydroxyphenyl)terephthalamide; 4,4′-dihydroxyazobenzene; 4,4′-dihydroxy-2,2′-dimethylazoxybenzene; 4,4′-dihydroxydiphenylacetylene; 4,4′-dihydroxychalcone; 4-hydroxyphenyl-4-hydroxybenzoate; dipropylene glycol, 1,4-butanediol, neopentyl glycol, poly(propylene glycol), thiodiglycol; the triglycidyl ether of tris (hydroxyphenyl)methane; the polyglycidyl ethers of a phenol or alkyl or halogen substituted phenol-aldehyde acid catalyzed condensation product (novolac resins); the tetraglycidyl amines of 4,4′-diaminodiphenylmethane; 4,4′-diaminostilbene; N,N′-dimethyl-4,4′-diaminostilbene; 4,4′-diaminobenzanilide; 4,4′-diaminobiphenyl; the polyglycidyl ether of the condensation product of a dicyclopentadiene or an oligomer thereof and a phenol or alkyl or halogen substituted phenol; and any combination thereof.

The epoxy resin which can be used as the epoxy resin compound (C) may also include an advancement reaction product of an epoxy resin with an aromatic di- and polyhydroxyl or carboxylic acid containing compound. The epoxy resin used for reacting with the aromatic di- and polyhydroxyl or carboxylic acid containing compound may include the epoxy resin of the non-seed oil based alkanolamide.

Examples of the aromatic di- and polyhydroxyl or carboxylic acid containing compound include hydroquinone, resorcinol, catechol, 2,4-dimethylresorcinol; 4-chlororesorcinol; tetramethylhydroquinone; bisphenol A (4,4′-isopropylidenediphenol); 4,4′-dihydroxydiphenylmethane; 4,4′-thiodiphenol; 4,4′-sulfonyldiphenol; 2,2′-sulfonyldiphenol; 4,4′-dihydroxydiphenyl oxide; 4,4′-dihydroxybenzophenone; 1,1-bis(4-hydroxyphenyl)-1-phenylethane; 4,4′-bis(4(4-hydroxyphenoxy)-phenylsulfone)diphenyl ether; 4,4′-dihydroxydiphenyl disulfide; 3,3′,3,5′-tetrachloro-4,4′-isopropylidenediphenol; 3,3′,3,5′-tetrabromo-4,4′-isopropylidenediphenol; 3,3′-dimethoxy-4,4′-isopropylidenediphenol; 4,4′-dihydroxybiphenyl; 4,4′-dihydroxy-α-methylstilbene; 4,4′-dihydroxybenzanilide;

bis(4-hydroxyphenyl)terephthalate; N,N′-bis(4-hydroxyphenyl)terephthalamide; bis(4′-hydroxybiphenyl)terephthalate; 4,4′-dihydroxyphenylbenzoate; bis(4′-hydroxyphenyl)-1,4-benzenediamine; 1,1′-bis(4-hydroxyphenyl)cyclohexane; phloroglucinol; pyrogallol; 2,2′,5,5′-tetrahydroxydiphenylsulfone; tris(hydroxyphenyl)methane; dicyclopentadiene diphenol; tricyclopentadienediphenol; terephthalic acid; isophthalic acid; 4,4′-benzanilidedicarboxylic acid; 4,4′-phenylbenzoatedicarboxylic acid; 4,4′-stilbenedicarboxylic acid; adipic acid; and any combination thereof.

Preparation of the aforementioned advancement reaction products may be performed using known methods, which usually include combining an epoxy resin with one or more suitable compounds having an average of more than one reactive hydrogen atom per molecule. The reactive hydrogen atom is the hydrogen atom which is reactive with an epoxide group in the epoxy resin. The ratio of the compound having more than one reactive hydrogen atom per molecule to the epoxy resin is generally from about 0.01:1 to about 0.95:1, preferably from about 0.05:1 to about 0.8:1, and more preferably from about 0.10:1 to about 0.5:1 equivalents of the reactive hydrogen atom per equivalent of the epoxide group in the epoxy resin.

Examples of these advancement reaction products may include dihydroxyaromatic, dithiol, disulfonamide or dicarboxylic acid compounds or compounds containing one primary amine or amide group, two secondary amine groups, one secondary amine group and one phenolic hydroxy group, one secondary amine group and one carboxylic acid group, or one phenolic hydroxy group and one carboxylic acid group, and any combination thereof.

The advancement reaction may be conducted, in the presence or absence of a solvent, with the application of heat and mixing. The advancement reaction may be conducted at atmospheric, superatmospheric, or subatmospheric pressures and at temperatures of from about 20° C. to about 260° C., preferably, from about 80° C. to about 240° C., and more preferably from about 100° C. to about 200° C.

The time required to complete the advancement reaction depends upon the factors such as the temperature employed, the chemical structure of the compound having more than one reactive hydrogen atom per molecule employed, and the chemical structure of the epoxy resin employed. Higher temperature may require shorter reaction time whereas lower temperature require longer period of the reaction time.

In general, the time for the advancement reaction completion may be ranged from about 5 minutes to about 24 hours, preferably from about 30 minutes to about 8 hours, and more preferably from about 30 minutes to about 4 hours.

A catalyst may also be added in the advancement reaction. Examples of the catalyst may include phosphines, quaternary ammonium compounds, phosphonium compounds and tertiary amines. The catalyst may be employed in quantities from about 0.01 to about 3, preferably from about 0.03 to about 1.5, and more preferably from about 0.05 to about 1.5 percent by weight based upon the total weight of the epoxy resin.

Other details concerning an advancement reaction useful in the present invention are given in U.S. Pat. No. 5,736,620 and Handbook of Epoxy Resins by Henry Lee and Kris Neville, incorporated herein by reference.

The epoxy resin of the non-seed oil based alkanolamide, Component (A), may be added to the epoxy resin compound (C) in a functionally equivalent amount. For example, the epoxy resin (A) may be added in quantities which will provide the epoxy resin composition with a range of desired properties, for example resistance to ultraviolet radiation, increased impact resistance, etc. according to the specific end use intended for the final epoxy resin composition.

In general, the epoxy resin of the non-seed oil based alkanolamide, Component (A), may be employed in an amount from about 0.5 to about 99 percent, preferably from about 5 to about 55 percent, and more preferably from about 10 to about 40 percent based upon the total weight of the epoxy resin composition.

The curable epoxy resin composition may also be blended with at least one additive including, for example, a cure accelerator, a solvent, a diluent (including non-reactive diluents, monoepoxide diluents, reactive non-epoxide diluents, and a diluent other than epoxy resin (A)), a modifier such as a flow modifier or a thickener, a reinforcing agent, a filler, a pigment, a dye, a mold release agent, a wetting agent, a stabilizer, a fire retardant agent, a surfactant, or any combination thereof.

These additives may be added in functionally equivalent amounts, for example, the pigment and/or dye may be added in quantities which will provide the composition with the desired color. In general, the amount of the additives may be from about zero to about 20, preferably from about 0.5 to about 5, and more preferably from about 0.5 to about 3 percent by weight based upon the total weight of the curable epoxy resin composition.

The cure accelerator which may be used herein includes, for example, mono, di, tri and tetraphenols; chlorinated phenols; aliphatic or cycloaliphatic mono or dicarboxylic acids; aromatic carboxylic acids; hydroxybenzoic acids; halogenated salicylic acids; boric acid; aromatic sulfonic acids; imidazoles; tertiary amines; aminoalcohols; aminopyridines; aminophenols, mercaptophenols; and any mixture thereof.

Particularly suitable cure accelerators include 2,4-dimethylphenol, 2,6-dimethylphenol, 4-methylphenol, 4-tertiary-butylphenol, 2-chlorophenol, 4-chlorophenol, 2,4-dichlorophenol, 4-nitrophenol, 1,2-dihydroxybenzene, 1,3-dihydroxybenzene, 2,2′-dihydroxybiphenyl, 4,4′-isopropylidenediphenol, valeric acid, oxalic acid, benzoic acid, 2,4-dichlorobenzoic acid, 5-chlorosalicylic acid, salicylic acid, p-toluenesulfonic acid, benzenesulfonic acid, hydroxybenzoic acid, 4-ethyl-2-methylimidazole, 1-methylimidazole, triethylamine, tributylamine, N,N-diethylethanolamine, N,N-dimethylbenzylamine, 2,4,6-tris(dimethylamino)phenol, 4-dimethylaminopyridine, 4-aminophenol, 2-aminophenol, 4-mercaptophenol, or any combination thereof.

Examples of the solvent which may be used herein include, for example, aliphatic and aromatic hydrocarbons, halogenated aliphatic hydrocarbons, aliphatic ethers, aliphatic nitriles, cyclic ethers, glycol ethers, esters, ketones, amides, sulfoxides, and any combination thereof.

Particularly suitable solvents include pentane, hexane, octane, toluene, xylene, methylethylketone, methylisobutylketone, N,N-dimethylformamide, dimethylsulfoxide, diethyl ether, tetrahydrofuran, 1,4-dioxane, dichloromethane, chloroform, ethylene dichloride, methyl chloroform, ethylene glycol dimethyl ether, diethylene glycol methyl ether, dipropylene glycol methyl ether, N-methylpyrrolidinone, N,N-dimethylacetamide, acetonitrile, sulfolane, and any combination thereof.

Examples of diluents which may be used herein include, for example, dibutyl phthalate, dioctyl phthalate, styrene, low molecular weight polystyrene, styrene oxide, allyl glycidyl ether, phenyl glycidyl ether, butyl glycidyl ether, vinylcyclohexene oxide, neopentylglycol diglycidyl ether, butanediol diglycidyl ether, hexanediol diglycidyl ether, diethylene glycol diglycidyl ether, dipropylene glycol diglycidyl ether, poly(propylene glycol) diglycidyl ether, thiodiglycol diglycidyl ether, maleic anhydride, ∈-caprolactam, butyrolactone, acrylonitrile, and any combination thereof.

Particularly suitable diluents include, for example, the epoxy resin diluents, such as the aforementioned neopentylglycol diglycidyl ether, butanediol diglycidyl ether, hexanediol diglycidyl ether, diethylene glycol diglycidyl ether, dipropylene glycol diglycidyl ether, poly(propylene glycol) diglycidyl ether, thiodiglycol diglycidyl ether, and any combination thereof.

The modifier such as thickener and flow modifier may be employed in amounts of from zero to about 10, preferably, from about 0.5 to about 6, and more preferably from about 0.5 to about 4 percent by weight based upon the total weight of the curable epoxy resin blend composition.

The reinforcing material which may be employed herein includes natural and synthetic fibers in the form of woven fabric, mat, monofilament, multifilament, unidirectional fiber, roving, random fiber or filament, inorganic filler or whisker, or hollow sphere. Other suitable reinforcing material includes glass, carbon, ceramics, nylon, rayon, cotton, aramid, graphite, polyalkylene terephthalates, polyethylene, polypropylene, polyesters, and any combination thereof.

The filler which may be employed herein includes, for example, inorganic oxide, ceramic microsphere, plastic microsphere, glass microsphere, inorganic whisker, calcium carbonate, and any combination thereof.

The filler may be employed in an amount from about zero to about 95, preferably from about 10 to about 80 percent, and more preferably from about 40 to about 60 percent by weight based upon the total weight of the curable epoxy resin blend composition.

According to the present invention, the cured epoxy resin is prepared by a process of curing the curable epoxy resin composition described above.

The process of curing of the curable epoxy resin blend composition of the present invention may be conducted at atmospheric, superatmospheric or subatmospheric pressures and at temperatures of from about 0° C. to about 300° C., preferably from about 25° C. to about 250° C., and more preferably from about 25° C. to about 200° C.

The time required to complete the process of curing the curable epoxy resin blend composition depends upon the temperature employed. Higher temperature requires shorter curing time whereas lower temperatures require longer curing time. Generally, the process may be completed in about 1 minute to about 48 hours, preferably from about 15 minutes to about 24 hours, and more preferably from about 30 minutes to about 12 hours.

It is also operable to partially cure (B-stage) the curable epoxy resin composition of the present invention to form a B-stage product and subsequently cure the B-stage product completely at a later time.

Certain of the epoxy resin compositions described herein may possess very low viscosity without the use of solvent and may not exhibit crystallization at room temperature, even after prolonged storage time. Additionally, if the epoxy resin composition comprises a low chloride (ionic, hydrolyzable and total) form of the epoxy resin, the resultant curable epoxy resin composition will also possess low chloride content with increased reactivity toward conventional epoxy resin curing agents, higher inherent di or polyglycidyl ether content, reduced corrosivity, and improved electrical properties.

The cured epoxy resins described herein may exhibit improvements in physical and mechanical properties. For example, the cured epoxy resin may have one or more of a high glass transition temperature, improved moisture and corrosion resistance, improved coating properties and compatibility with conventional epoxy resin curing agents, better coating quality, improved resistance to methylethylketone, increased hardness, and higher impact resistance and bending resistance, with no loss of adhesion, resistance to ultraviolet radiation (non-chalking coatings) and rapid cure.

The epoxy resins may be useful in coatings, especially protective coatings which provide solvent resistant, moisture resistant, abrasion resistant, and weatherable properties; electrical or structural laminate or composite; filament windings; moldings; castings; encapsulation; stabilizer additives for plastics; and the like.

### EXAMPLES

The following standard analytical equipment and method is used in the Examples:

Percent Epoxide/Epoxide Equivalent Weight (EEW) Analysis

A standard titration method was used to determine percent epoxide in the various epoxy resins. A sample was weighed (ranging from about 0.1-0.2 g) and dissolved in dichloromethane (15 mL). Tetraethylammonium bromide solution in acetic acid (15 mL) was added to the sample. The resultant solution was treated with 3 drops of crystal violet solution (0.1% w/v in acetic acid) and was titrated with 0.1 N perchloric acid in acetic acid on a Metrohm 665 Dosimat titrator (Brinkmann). Titration of a blank sample comprising dichloromethane (15 mL) and tetraethylammonium bromide solution in acetic acid (15 mL) provided correction for solvent background. General methods for this titration are found in scientific literature, for example, Jay, R. R., “Direct Titration of Epoxy Compounds and Aziridines”, Analytical Chemistry, 36, 3, 667-668 (March, 1964).

The following Examples further illustrate the present invention in detail but are not to be construed to limit the scope thereof.

### Example 1

### Synthesis of a Polyglycidyl Ether from an Alkanolamide Prepared From Adipic Acid and Diethanolamine

A one liter, three neck, glass, round bottom reactor was charged under nitrogen with epichlorohydrin (222.07 grams. 2.4 moles), sodium hydroxide (pellets, anhydrous, reagent grade, ≧98%) (26.88 grams, 0.672 moles), and sodium sulfate (granular anhydrous) (59.68 grams, 0.42 mole). The reactor was additionally equipped with a condenser (maintained at 0° C.), a thermometer, a Claisen adaptor, an overhead nitrogen inlet (1 LPM N₂ used), a ground glass stopper, and a stirrer assembly (TEFLON paddle, glass shaft, variable speed motor). Solid alkanolamide from the condensation reaction of adipic acid and diethanolamine (25.51 grams, 0.30 —OH equivalents) was weighed into a bottle and sealed. The structure of the alkanolamide used was:

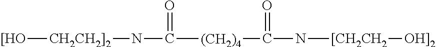

High pressure liquid chromatographic (HPLC) analysis demonstrated a purity of 98.3 area % with the balance comprising a single minor component. All glassware used for the epoxidation reaction was pre-dried in the oven for >48 hours at 150° C. Stirring commenced to give a 24° C. slurry of sodium hydroxide and sodium sulfate in epichlorohydrin. After stirring for 7 minutes, heating of the reactor commenced using a thermostatically controlled heating mantle. Once the stirred slurry equilibrated at 40° C., an initial aliquot of the solid alkanolamide (2.77 grams) was added to the reactor using a spatula. The reaction temperature was maintained at 40° C. during the addition of the aliquots unless otherwise noted. The aliquots were added as follows:

| Cumulative time from | | |
|---|---|---|
| Addition | Amount of Aliquot | |
| of 1^{st} Aliquot (minutes) | (grams) | Observations |
| 20 | 3.35 | Light orange colored slurry |
| 40 | 2.58 | |
| 60 | 2.76 | |
| 80 | 2.55 | Light orange colored slurry |
| 100 | 1.95 | |
| 120 | 3.19 | |
| 140 | 2.87 | |
| 160 | 3.49 | Light tan colored slurry |

The progress of the epoxidation reaction was monitored by HPLC. After a cumulative 19.67 hours of reaction, heating of the thin, tan colored slurry ceased followed by addition of methylisobutylketone (400 milliliters) and cooling of the reactor exterior to 25° C. with a fan. The methylisobutylketone slurry was vacuum filtered over a one inch pad of diatomaceous earth supported on an 600 milliliter coarse fritted glass funnel. Rotary evaporation of the filtrate using a maximum oil bath temperature of 70° C. provided 25.48 grams of very slightly hazy golden amber colored liquid. The product was dissolved in anhydrous toluene (250 milliliters), and then vacuum filtered over a one-half inch pad of diatomaceous earth supported on a 600 milliliter coarse fritted glass funnel. Rotary evaporation of the filtrate using a maximum oil bath temperature of 140° C. for one hour gave 21.27 grams of clear, light golden amber colored liquid. GC analysis revealed that essentially all light boiling components, including residual epichlorohydrin and diglycldyl ether co-product had been removed. Titration of a pair of aliquots of the product obtained demonstrated an average of 30.67% epoxide

(140.3 epoxide equivalent weight). Infrared spectrophotometric analysis of neat thin films of both the alkanolamide reactant and the polyglycidyl ether thereof on a KCl plate confirmed (note: the film of the alkanolamide reactant was prepared by melting the solid on the KCl plate):

(1) complete maintenance of the integrity of the amide linkage in the polyglycidyl ether at 1640.6 cm⁻¹,

(2) conversion of hydroxyl groups to glycidyl ether groups with only a very minor hydroxyl absorbance present in the polyglycidyl ether at 3432.7 cm⁻¹,

(3) appearance of a strong aliphatic ether C-0 stretch at 1111.0 cm⁻¹ in the polyglycidyl ether, and

(4) appearance of epoxide ether C-0 stretch at 1254.9, 906.6, and 854.0 cm⁻¹ in the polyglycidyl ether.

The resulting polyglycidyl ether is illustrated below.

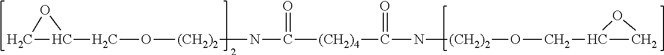

### Example 2

### Preparation and Testing of Coatings Based on the Polyglycidyl Ether from Example 1

15.02 grams of the polyglycidyl ether from Example 1 (140.3 epoxide equivalent weight; 0.107 equivalents), 9.85 grams of ANCAMINE 2074 curing agent (92 hydrogen equivalent weight; 0.107 equivalents, available from Air Products), and 3 drops of BYK™ 310 were combined in a glass bottle. These components were then stirred to obtain a homogeneous, clear liquid. From this liquid, coatings were drawn on 0.03 inch by 4 inch by 12 inch unpolished, cold roll steel panels using a #48 draw down bar from BYK Chemie USA. This formulation was also applied to 3 inch by 6 inch unpolished, coil coat white panels using a 10 mil draw down bar (also from BYK Chemie). BYK drying tests were performed in triplicate, and results at room temperature for this formulation were as follows:

Set to Touch Time=4.5 hours

Dust Time=5.2 hours

Dry-Through Time=10.5 hours

The coatings from the above formulation were cured for 2 days at ambient conditions and then post cured for 24 hours at 140° C. in a forced air convection oven. After cure, the coating thicknesses were measured using a Fisherscope Film Thickness Meter. The coatings were then tested. The properties obtained from the testing of the coatings on the cold roll steel panels are given below:

Coating Thickness=2.147 mils

Glass Transition Temperature, by Differential Scanning Calorimetry=70° C.

Pendulum (Konig) Hardness by ASTM D 4368=152 seconds

Pencil Hardness by ASTM D 3383=2 B

⅛ inch Conical Mandrel Bend by ASTM D 522-93a=No Failure

Cross Hatch Adhesion by ASTM D 3359-90=2 B

Impact Strength Direct/Reverse by ASTM D 2794=136/40 in. lbs.

Methyl Ethyl Ketone Double Rubs by ASTM D 5402=>200

For the coatings on the coil coat white panels, the average thickness was 4.281 mils. The gloss for these coatings was measured using a glossmeter according to ASTM method D-523. The average gloss (percent light reflectance) at angles of 60° and 85° were 72 and 88, respectively. The panels were then placed in an apparatus described in ASTM Method G-53 in which they were alternately exposed to 4 hours of ultraviolet light at 60° C. and to 4 hours of water condensation at 50° C. in a repetitive cycle. The ultraviolet irradiation in this apparatus was from an array of UV-A type lamps operating at a wavelength of 340 nm. To determine the effect of these conditions on the gloss, the panels were periodically removed from the apparatus and measurements were made. After 3000 hours of this test, a high level of gloss retention was observed for these coated panels. At 350 hours of exposure, the gloss at angles of 60° and 85° for the coated panels are 42 (58% of original value) and 62 (70% of original value), respectively.

As described above, anhydrous epihalohydrin epoxidation for non-seed oil based alkanolamides and carboxylic acids derived from these monomers may result in new glycidyl ethers and esters with cure rates comparable to conventional epoxy resins. Having this new level of reactivity may allow application in coatings where the alkanolamide structure may provide improved processing and performance for conventional epoxy resins.

Advantageously, embodiments disclosed herein may provide for one or more of: lower viscosities, which may eliminate the need for solvents in coatings formulations (no VOC's); excellent UV stability in combination with good adhesion and corrosion resistance, which may eliminate the need for multiple coats in many industrial, marine, and automotive applications; and improved flexibility and damage tolerance for epoxy resin coatings. Additionally, compositions described herein may have higher crosslink density (improved thermal stability), improved reactivity due to the structural design of the backbone, higher degrees of epoxidation (fewer side-products), and glycidyl ether functionality.

### Example 3

### A. Preparation of an Alkanolamide Synthesized from 1,3- and 1,4-Cyclohexanedicarboxylic Acid and Diethanolamine

1,3-Cyclohexanedicarboxylic acid (25.00 grams, 0.145 mole, 0.29 —COOH equivalent), 1,4-cyclohexanedicarboxylic acid (25.00 grams, 0.145 mole, 0.29 —COOH equivalent), 0.52 gram of 85% KOH in methanol (10 milliliters), and diethanolamine (244.24 grams; 2.323 moles, 2.323 —NH equivalents) were placed in a 500 milliliter, single neck, round bottom flask. The flask was placed on a rotary evaporator using a hot oil bath temperature of 80° C. and a vacuum of 378 mm Hg. After one minute of rotary evaporation the hot oil bath temperature was set to 130° C. and vacuum had decreased to 286 mm Hg. The vacuum was continually decreased until 30 mm Hg was attained after a cumulative 12 minutes of rotary evaporation. The contents of the flask became clear at this time with bubbling. After a cumulative 4.7 hours of rotary evaporation, the vacuum had decreased to 20 mm Hg and rotary evaporation ceased. The contents of the flask were transferred to a 1 liter, single neck, round bottom flask along with benzene (300 milliliters) and placed back on the rotary evaporator at an oil bath temperature 70° C. and vacuum of 616 mm Hg. After 30 minutes rotary evaporation ceased and the product was recovered and added to a separatory funnel. The top layer of hot benzene was removed, discarded, and the bottom layer added back to the flask along with fresh benzene (300 milliliters). Using the aforementioned method, the extraction with benzene was completed 4 additional times (5 times total). The product remaining after these extractions was rotary evaporated using a maximum oil bath temperature of 130° C. under full vacuum. FTIR spectrophotometric analysis of a sample of the product from this rotary evaporation demonstrated a strong amide absorbance (1615.8 cm⁻¹) accompanied by a very minor ester absorbance (1732.8 cm⁻¹). A portion of the product (123.8 grams) was removed and rotary evaporated using at an oil bath temperature of 180° C. under full vacuum, reducing product weight by 3.1 grams. A slurry of this product formed by addition of methylisobutylketone

(200 milliliters) was added to a one liter separatory funnel and washed 4 times with 100 milliliter portions of % 5 by weight sodium hydrogen carbonate followed by a final wash with DI water (100 milliliters). The washed methylisobutylketone slurry was dried over anhydrous magnesium sulfate and filtered through a medium fritted glass funnel. The filtrate was rotary evaporated at an oil bath temperature of 75° C. to remove the bulk of the solvent, then at 110° C. under full vacuum for one hour. The final product (97.05 grams) was a light amber colored, transparent, viscous liquid at ambient temperature. FTIR spectrophotometric and ¹H NMR analyses supported an amide polyol structure. HPLC analysis revealed 100 area % consisting of 3 peaks with a shoulder present on one of the peaks (the 4 components are proposed to be the cis, trans-1,3- and 1,4-cyclohexyl isomers of the alkanolamide).

### B. Synthesis of a Polyglycidyl Ether of an Alkanolamide of 1,3- and 1,4-Cyclohexanedicarboxylic Acid and Diethanolamine

A one liter, three neck, glass, round bottom reactor was charged under nitrogen with epichlorohydrin (231.43 grams. 2.5 moles), sodium hydroxide (pellets, anhydrous, reagent grade, >98%) (40.0 grams, 1.0 mole), and sodium sulfate (granular, anhydrous) (99.43 grams, 0.70 mole). The reactor was additionally equipped with a condenser (maintained at 0° C.), a thermometer, a Claisen adaptor, an overhead nitrogen inlet (1 LPM N₂ used), a ground glass stopper, and a stirrer assembly (TEFLON paddle, glass shaft, variable speed motor). Pre-warmed solid alkanolamide from the condensation reaction of 1,3- and 1,4-cyclohexanedicarboxylic acid and diethanolamine from A. above (43.05 grams, 0.50 —OH equivalent) was added to a side arm vented addition funnel then attached to the reactor. Stirring commenced to give a 24° C. slurry of sodium hydroxide and sodium sulfate in epichlorohydrin. After stirring for 15 minutes, heating of the reactor commenced using a thermostatically controlled heating mantle. Once the stirred slurry equilibrated at 40° C., an initial aliquot of alkanolamide (10 milliliters) was added to the reactor over a 2 minute period. Three additional aliquots of alkanolamide (10 milliliters) were added at 15 minute intervals while maintaining the reaction temperature at 40-43° C. during the addition of the aliquots. The progress of the epoxidation reaction was monitored by HPLC. Thirty minutes after the alkanolamide addition was complete, HPLC analysis of an aliquot of the reaction product revealed 85.6% conversion of the alkanolamide. After a cumulative 16.17 hours of reaction, HPLC analysis revealed that 100% conversion of the alkanolamide had been achieved. After a cumulative 16.75 hours of reaction, heating of the thin, light tan colored slurry ceased followed by cooling of the reactor exterior to 25° C. using a fan and addition of dichloromethane (500 milliliters). The dichloromethane slurry was equally divided into 4 polypropylene bottles which were sealed and centrifuged at 2000 RPM for one hour. The top layer of transparent liquid was decanted through a pad of diatomaceous earth (½ inch of Celite™ 545 bottom layer, ½ inch Celite™ 577 middle layer, ½ inch of Celite™ 545 top layer) supported on a 600 milliliter medium fritted glass funnel using a side arm flask with vacuum. The solids remaining in the bottles were equally diluted using fresh dichloromethane to a total weight of 300 grams and then placed on the mechanical shaker for one hour, followed by centrifuging and decantation, as previously described. Additional dichloromethane (50 milliliters) was used to wash the product remaining in the contents of the filter into the filtrate. Rotary evaporation of the filtrate finishing with a maximum oil bath temperature of 125° C. for one hour provided 41.88 grams of tacky white solid. GC analysis revealed that essentially all light boiling components, including residual epichlorohydrin and diglycidyl ether co-product had been removed. Titration of a pair of aliquots of the product obtained demonstrated and average of 25.15% epoxide (171.09 EEW). FTIR spectrophotometric analysis of neat thin films of both the alkanolamide reactant and the polyglycidyl ether thereof on a KCl plate confirmed:

(1) maintenance of the integrity of the amide linkage in the polyglycidyl ether at 1636.0 cm⁻¹ and 1615.8 cm⁻¹ for the alkanolamide reactant,

(2) conversion of hydroxyl groups at 3313.3 cm⁻¹ in the alkanolamide reactant with minor hydroxyl absorbance present in the polyglycidyl ether at 3259.6 cm⁻¹ (shoulder also present),

(3) appearance of a strong aliphatic ether C-0 stretch at 1107.7 cm⁻¹ in the polyglycidyl ether, and

(4) appearance of epoxide ether C-0 stretch at 1254.1, 909.4 and 853.6 cm⁻¹ in the polyglycidyl ether.

Both the alkanolamide reactant and the polyglycidyl ether product possessed a minor absorbance (1734.7 plus 1717.4 and 1728.2 cm⁻¹, respectively) which may be indicative of a slight amount of ester functionality.

1. An epoxy resin comprising at least one epoxy amide derived from at least one non-seed oil based alkanolamide.

2. The epoxy resin according to claim 1, comprising a glycidyl ether derived from non-seed oil based alkanolamides, and any oligomer thereof; or comprising a diglycidyl ether derived from non-seed oil based alkanolamides, and a monoglycidyl ether derived from non-seed oil based alkanolamides.

3. A process for preparing an epoxy resin comprising reacting (a) at least one non-seed oil based alkanolamide, (b) an epihalohydrin, and (c) a basic acting substance; and (d) optionally, a solvent.

4. The process according to claim 3, further comprising first reacting a glycidyl ether derived from the non-seed oil based alkanolamides with an alkali metal hydride to form an intermediate product, followed by reacting the intermediate product with the epihalohydrin; and wherein the alkali metal hydride is at least one of sodium hydride and potassium hydride.

5. The process according to claim 3, wherein the process is a slurry epoxidation process; and wherein the slurry epoxidation process comprises reacting (a) the glycidyl ether derived from non-seed oil based alkanolamides; (b) the epihalohydrin; (c) the basic acting substance in an solid form or in an aqueous solution; (d) optionally, a solvent other than water; (e) optionally, the catalyst; and (f) optionally, a dehydrating agent.

6. The process according to claim 5, further comprising (i) adding the solvent other than water to the basic acting substance in the aqueous solution, and (ii) removing the aqueous solution (water) from the basic acting substance via a vacuum distillation of a solvent-water azeotrope until the basic acting substance becomes a neat solid or a solvent slurry; and wherein the solvent comprises toluene or xylene.

7. The process according to claim 5, wherein an additional epihalohydrin is back-added to the reaction; and wherein the amount of the additional epihalohydrin added is from about 0.25 to about 1 equivalents of epichlorohydrin per primary hydroxyl group.

8. The process according to claim 3, wherein the process is an anhydrous epoxidation process; and wherein the anhydrous epoxidation process comprises reacting (a) the glycidyl ether derived from non-seed oil based alkanolamides, (b) the epihalohydrin, and (c) the basic acting substance in an aqueous solution, optionally (d) the solvent, and optionally (e) the catalyst.

9. The process according to claim 8 further comprising removing the aqueous solution (water) from the basic acting substance via a vacuum distillation of an epichlorohydrin-water azeotrope until the basic acting substance becomes a substantially anhydrous solid.

10. The process according to claim 3, wherein the process is a Lewis acid catalyzed coupling and epoxidation process; and wherein the Lewis acid catalyzed coupling and epoxidation process comprises reacting, in a coupling reaction, (a) the glycidyl ether derived from non-seed oil based alkanolamides, (b) the epihalohydrin in the presence of (c) a Lewis acid catalyst, followed by dehydrohalogenation reaction of the resultant halohydrin intermediate using (d) the basic acting substance in an aqueous solution, optionally (e) the solvent and, optionally (f) the catalyst other than the Lewis acid catalyst.

11. The process according to claim 10, wherein the coupling reaction comprises reacting the glycidyl ether derived from non-seed oil based alkanolamides with the epihalohydrin in the presence the Lewis acid catalyst to form a halohydrin intermediate; and wherein the coupling reaction further comprises a dehydrohalogenation reaction in which the halohydrin intermediate is reacted with the basic acting substance in the aqueous solution to form the epoxy resin.

12. An article comprising the epoxy resin according to claim 1; and wherein the article is at least one of a coating, an electrical or structural laminate, an electrical or structural composite, a filament winding, a molding, a casting, an adhesive or an encapsulation.

13. An epoxy resin reactive composition comprising an epoxy resin (A) and a resin compound (B), wherein the epoxy resin (A) comprises a glycidyl ether derived from non-seed oil based alkanolamides and the resin compound (B) comprises one or more epoxy resins other than the epoxy resin (A).

14. A curable epoxy resin composition comprising (a) the epoxy resin reactive composition according to claim 1; and (b) at least one curing agent and/or at least one curing catalyst.

15. A curable epoxy resin blend composition comprising a blend of (a) the epoxy resin reactive composition according to claim 13; and (b) at least one curing agent and/or at least one curing catalyst; and wherein the curing agent comprises a material having at least one reactive hydrogen atom per molecule, and the epoxy resin reactive composition comprises at least one epoxide group, and the reactive hydrogen atom in the curing agent is reactive with the epoxide group in the epoxy resin reactive composition.

16. A process comprising curing the curable epoxy resin blend composition according to claim 15.

17. An article comprising the cured epoxy resin prepared by the process according to claim 16; and wherein the article is at least one of a coating, an electrical or structural laminate, an electrical or structural composite, a filament winding, a molding, a casting, an adhesive and an encapsulation.
